(19) United States
(12) Patent Application Publication
(10) Pub. No.: US 2023/0269228 A1
(43) Pub. Date: Aug. 24, 2023

(54) PRE-EMPTIVE FLOW DROPPING IN A CLOUD-BASED SECURE ACCESS SERVICE

(71) Applicant: Cisco Technology, Inc., San Jose, CA (US)

(72) Inventors: Kyle Andrew Donald Mestery, Woodbury, MN (US); Mark A. Bakke, Maple Grove, MN (US); William Mark Townsley, San Francisco, CA (US)

(21) Appl. No.: 17/585,204

(22) Filed: Jan. 26, 2022

(51) Int. Cl. H04L 9/40; H04L 45/00; H04L 45/42

(52) U.S. Cl. CPC H04L 63/0263; H04L 45/38; H04L 45/42; H04L 63/0236

(57) ABSTRACT

The present disclosure is directed to managing network traffic in a cloud-based secure access service. In one aspect, a method includes determining, by a controller of a cloud-based secure access service, that data packets from a user device should be dropped, a plurality of user devices, including the user device, being remotely connected to the controller for access to the cloud-based secure access service; determining, by the controller, a type of remote connection through which the user device is connected to the controller, each type of remote connection having a corresponding communication prototype; and transmitting a message, by the controller, to the user device, over a control protocol corresponding to the type of remote connection through which the user device is connected to the controller, the message providing a signal to the user device to drop packets at the user device prior to sending the packets to the controller.

### TECHNICAL FIELD

The present technology pertains to addressing security of wireless networks, and in particular to network traffic management at a cloud-based secure access service accessible to remotely connected user devices.

### BACKGROUND

Secure Access Service Edge (SASE) combines networking and security functions in the cloud to deliver seamless, secure access to applications, anywhere users work. Example functionalities provided by SASE include, but are not limited to, software-defined wide area network, secure web gateway, firewall as a service, cloud access security broker, and zero-trust network access. The SASE model aims to consolidate these functions in a single, integrated cloud service.

As the number of connected user devices to a SASE service increases, so do challenges of maintaining delivery of reliable services to remotely connected user devices in a timely fashion.

### BRIEF DESCRIPTION OF THE DRAWINGS

FIG. 1 illustrates an example cloud computing architecture, according to some aspects of the present disclosure;

FIG. 2 illustrates an example fog computing architecture, according to some aspects of the present disclosure;

FIG. 3 illustrates an example SASE based architecture, according to some aspects of the present disclosure;

FIG. 4 illustrates several components of a SASE controller, according to some aspects of the present disclosure;

FIG. 5 illustrates an example method of managing network traffic in an environment utilizing a SASE architecture, according to some aspects of the present disclosure;

FIG. 6 illustrates an example computing system architecture, according to some aspects of the present disclosure; and

FIG. 7 illustrates an example network device, according to some aspects of the present disclosure.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

### Overview

Systems, methods, and computer-readable media are disclosed for managing network traffic (transmission of data packets) in a cloud-based service that remotely connects endpoints using a Secure Access Service Edge (SASE) architecture. In some aspects, network traffic management in a SASE architecture includes a determination at the cloud-based SASE controller (e.g., a datacenter) that certain network traffic from certain remotely connected user devices should be dropped followed by a pre-emptive dropping of such traffic at the corresponding remotely connected user device before the traffic reaches a headend component at a cloud-based SASE controller.

In one aspect, a method includes determining, by a controller of a cloud-based secure access service, that data packets from a user device should be dropped, a plurality of user devices, including the user device, being remotely connected to the controller for access to the cloud-based secure access service; determining, by the controller, a type of remote connection through which the user device is connected to the controller, each type of remote connection having a corresponding communication prototype; and transmitting a message, by the controller, to the user device, over a control protocol corresponding to the type of remote connection through which the user device is connected to the controller, the message providing a signal to the user device to drop packets at the user device prior to sending the packets to the controller.

In another aspect, the user device is connected to the controller through a cloud headend of the controller.

In another aspect, determining that the data packet should be dropped includes identifying the user device; determining that at least one prior rule for network traffic management are stored for the user device; and transmitting, before receiving the data packets, a message using the control protocol to direct the user device to proactively drop future traffic originating from the user device based on the at least one prior rule.

In another aspect, the proactive dropping of future traffic is implemented upon the user device reconnecting to the cloud-based secure access service.

In another aspect, the proactive dropping of future traffic is implemented upon the user device connecting to the cloud-based secure access service for a first time.

In another aspect, the at least one prior rule is stored with reference to management of network traffic of at least one other remotely connected device of the same type as the user device.

In another aspect, the data packets are determined to be drop by a cloud-delivered firewall service at the controller.

In another aspect, determining that the data packet should be dropped includes receiving a data packet from the user device at a remote access headend of the controller; sending the data packet from the remote access headend to a routing component of the controller; and sending the data packet from the routing component to at least one cloud-delivered firewall of the cloud-based secure access service.

In one aspect, a cloud-based secure access service includes a controller configured to determine that data packets from a user device should be dropped, a plurality of user devices, including the user device, being remotely connected to the controller for access to the cloud-based secure access service; determine a type of remote connection through which the user device is connected to the controller, each type of remote connection having a corresponding communication prototype; and transmit a message to the user device, over a control protocol corresponding to the type of remote connection through which the user device is connected to the controller, the message providing a signal to the user device to drop packets at the user device prior to sending the packets to the controller.

In another aspect, one or more non-transitory computer-readable media include computer-readable instructions, which when executed by a controller of a cloud-based secure access service, causes the controller to determine that data packets from a user device should be dropped, a plurality of user devices, including the user device, being remotely connected to the controller for access to the cloud-based secure access service; determine a type of remote connection through which the user device is connected to the controller, each type of remote connection having a corresponding communication prototype; and transmit a message to the user device, over a control protocol corresponding to the type of remote connection through which the user device is connected to the controller, the message providing a signal to the user device to drop packets at the user device prior to sending the packets to the controller.

### Example Embodiments

As noted above, a SASE service combines networking and security functions in the cloud to deliver seamless, secure access to applications, anywhere users work. Example functionalities provided by SASE include, but are not limited to, software-defined wide area network, secure web gateway, firewall as a service, cloud access security broker, and zero-trust network access. The SASE model aims to consolidate these functions in a single, integrated cloud service.

As the number of connected user devices to a SASE service increases, so do challenges of maintaining delivery of reliable services to remotely connected user devices in a timely fashion. There is a need for improving cloud resource utilization and optimization of network performance. This need can be important to a cloud-based SASE services (e.g., Frontizo developed by Cisco, Inc. of San Jose, CA) as it serves to mesh and stitch together a number of different Software-Defined Wide Area Networks (SDWANs) and connected devices and provide access to public/private cloud based services to such connected devices. Further, when utilizing an SDWAN in combination with a cloud delivered firewall, the optimal place to drop packets is as close to the user’s edge device (a user device) as possible. Determining whether a flow needs to be dropped or not can be done at the cloud, but ideally it would be better to drop the flow at the edge device, or as close to the edge device as possible. This saves bandwidth inside the cloud-based SASE service and provides a better experience for a user at the user device.

When flows from a remote user device pass through a firewall of the cloud-based secure access service, they can be dropped in accordance with certain network security policies set for the flow (based on the user, device, etc.). Currently, packets are dropped at Cloud-Delivered Firewalls (CDFWs) inside a SASE controller. Therefore, network traffic still needs to enter the SASE controller, be processed, and sent to a CDFW (through the headend and a routing device) before being dropped. Throughout this disclosure, a CDFW can include any known or to be developed component that can determine whether or not to drop data packets including, but not limited to, a secure web gateway, a web proxy, etc.

The present disclosure provides systems and methods to manage network traffic (transmission of data packets) in a SASE based environment to optimize resource utilization at various components within a cloud-based SASE controller. In some examples, network traffic management in a SASE architecture includes a determination at the cloud-based SASE controller (e.g., a datacenter) that certain network traffic from certain remotely connected user devices should be dropped followed by a pre-emptive dropping of such traffic at the corresponding remotely connected user device before the traffic reaches a headend component at the cloud-based SASE controller.

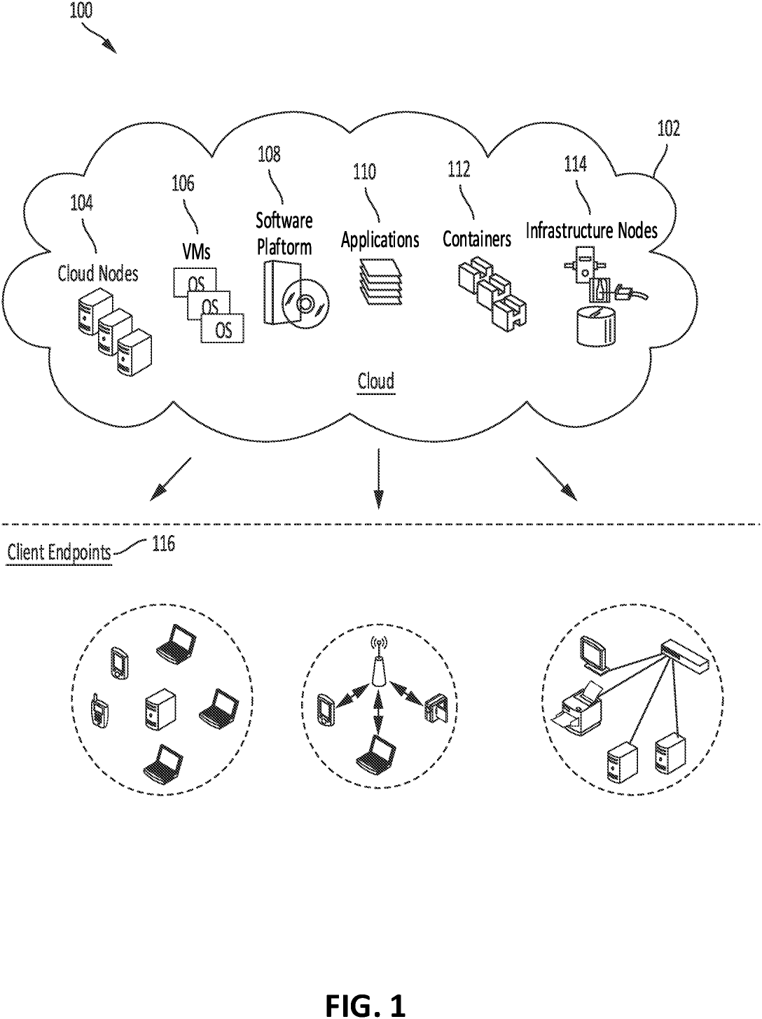

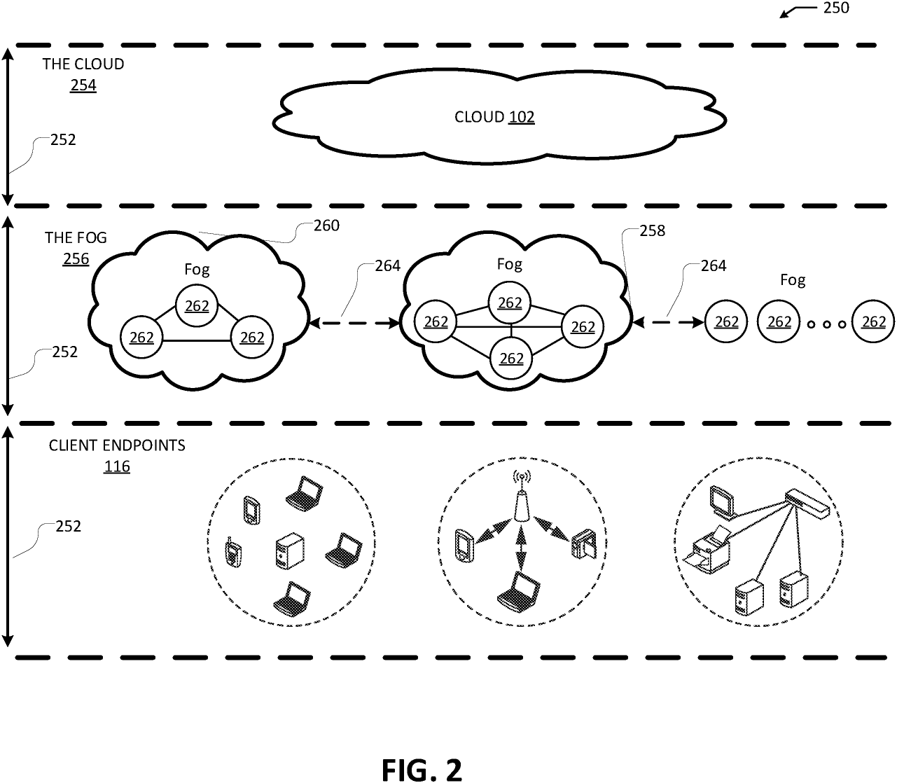

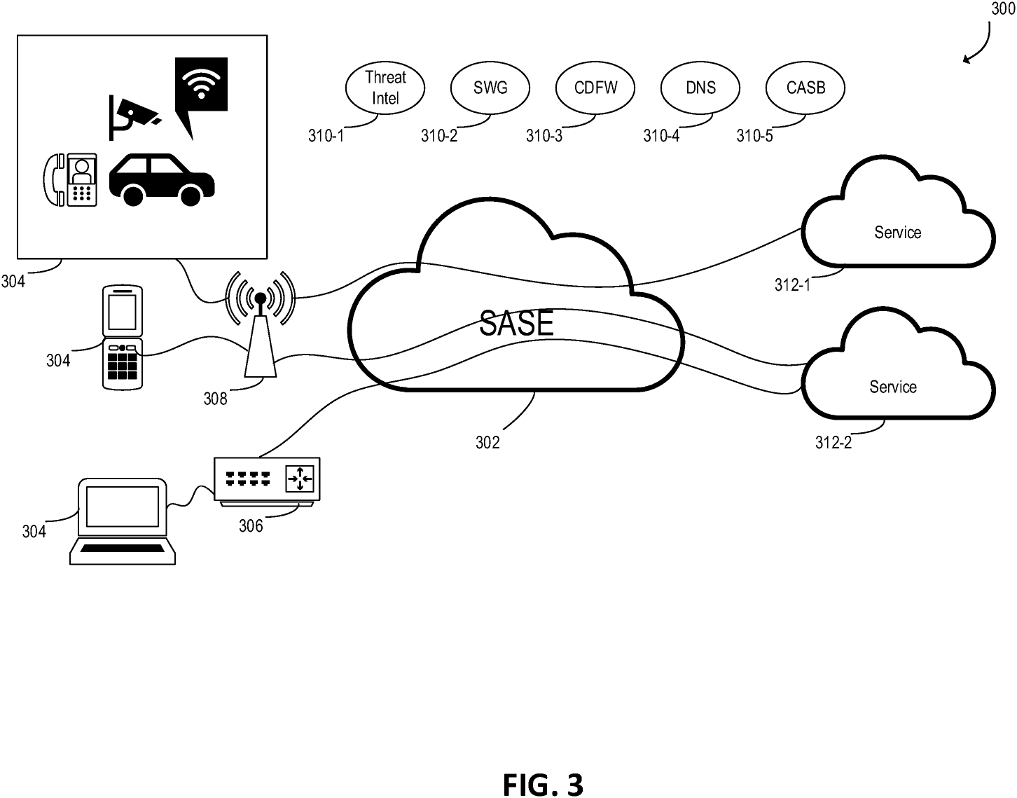

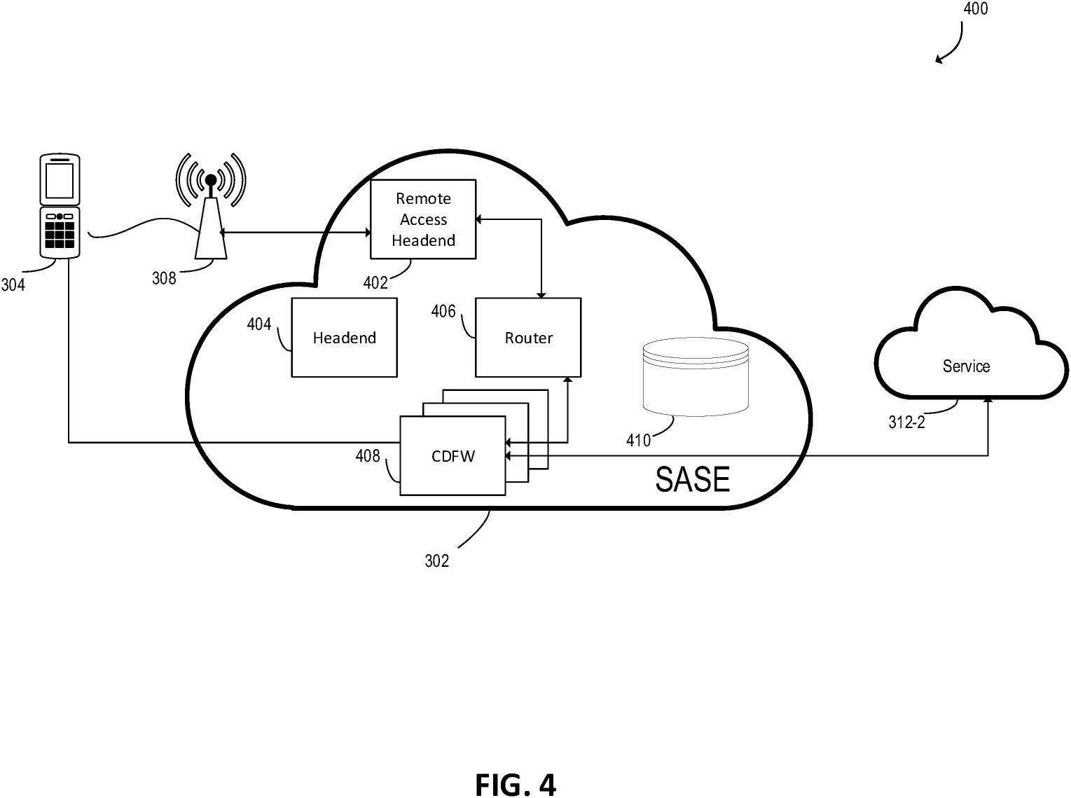

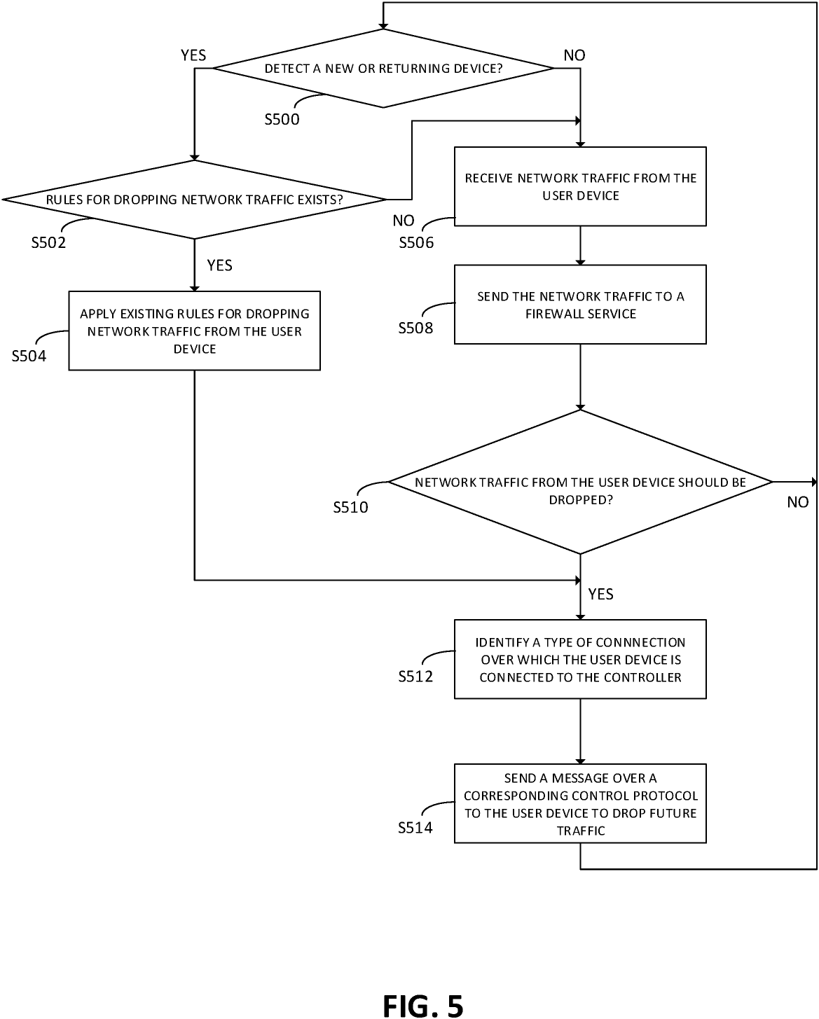

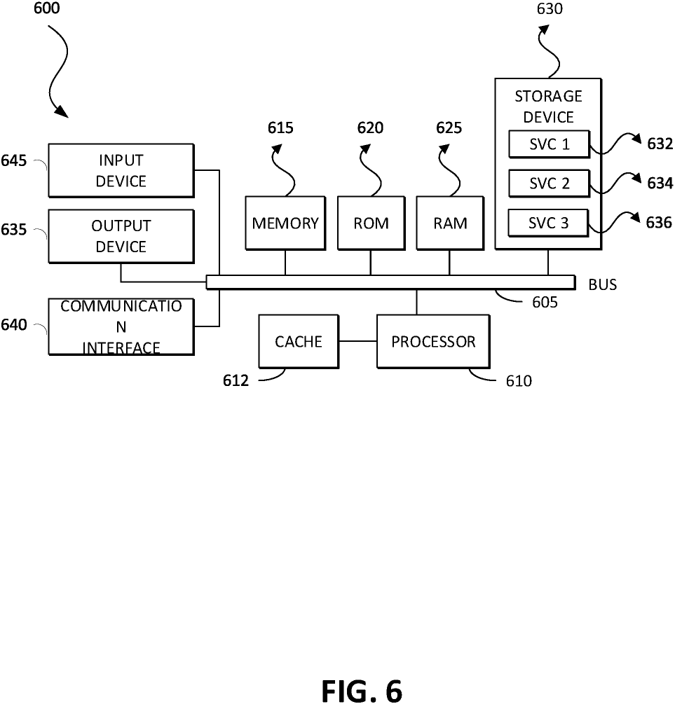

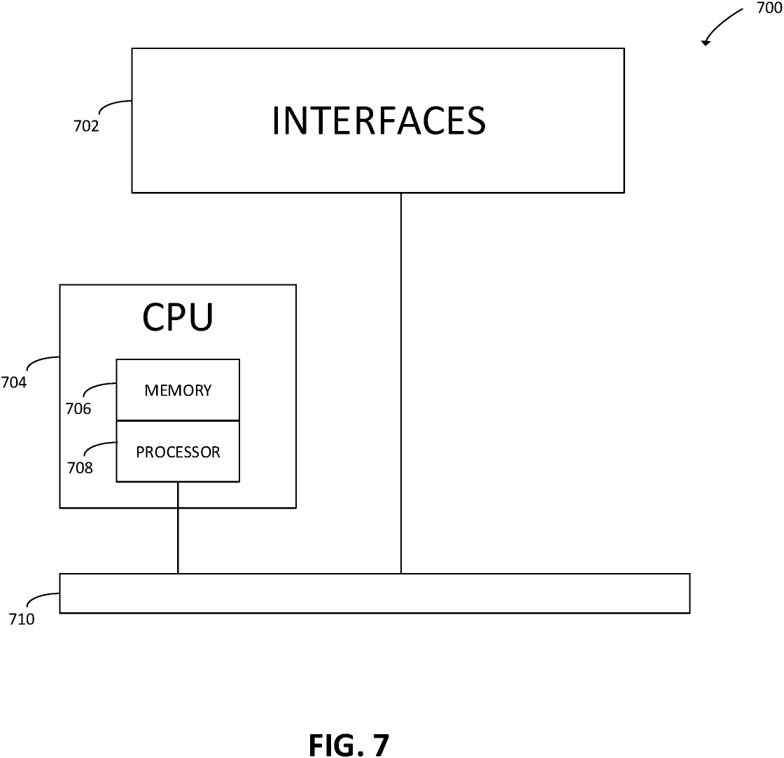

A description of example network environments and architectures for network data access and services, as illustrated in FIGS. 1 and 2, is first disclosed herein. One or more examples of a SASE based architecture are described with reference to FIGS. 3 and 4. An example process for managing network traffic in a SASE based environment in described next with reference to FIG. 5. The discussion then concludes with a brief description of example devices, as illustrated in FIGS. 6 and 7.

FIG. 1 illustrates a diagram of an example cloud computing architecture 100. The architecture can include a cloud 102. The cloud 102 can include one or more private clouds, public clouds, and/or hybrid clouds. Moreover, the cloud 102 can include cloud elements 104-114. The cloud elements 104-114 can include, for example, servers 104, virtual machines (VMs) 106, one or more software platforms 108, applications or services 110, software containers 112, and infrastructure nodes 114. The infrastructure nodes 114 can include various types of nodes, such as compute nodes, storage nodes, network nodes, management systems, etc.

The cloud 102 can provide various cloud computing services via the cloud elements 104-114, such as software as a service (SaaS) (e.g., collaboration services, email services, enterprise resource planning services, content services, communication services, etc.), infrastructure as a service (IaaS) (e.g., security services, networking services, systems management services, etc.), platform as a service (PaaS) (e.g., web services, streaming services, application development services, etc.), and other types of services such as desktop as a service (DaaS), information technology management as a service (ITaaS), managed software as a service (MSaaS), mobile backend as a service (MBaaS), etc.

The client endpoints 116 can connect with the cloud 102 to obtain one or more specific services from the cloud 102. The client endpoints 116 can communicate with elements 104-114 via one or more public networks (e.g., Internet), private networks, and/or hybrid networks (e.g., virtual private network). The client endpoints 116 can include any device with networking capabilities, such as a laptop computer, a tablet computer, a server, a desktop computer, a smartphone, a network device (e.g., an access point, a router, a switch, etc.), a smart television, a smart car, a sensor, a GPS device, a game system, a smart wearable object (e.g., smartwatch, etc.), a consumer object (e.g., Internet refrigerator, smart lighting system, etc.), a city or transportation system (e.g., traffic control, toll collection system, etc.), an internet of things (IoT) device, a camera, a network printer, a transportation system (e.g., airplane, train, motorcycle, boat, etc.), or any smart or connected object (e.g., smart home, smart building, smart retail, smart glasses, etc.), and so forth.

FIG. 2 illustrates a diagram of an example fog computing architecture 250. The fog computing architecture 250 can include the cloud layer 254, which includes the cloud 102 of FIG. 1 and any other cloud system or environment, and the fog layer 256, which includes fog nodes 262. The client endpoints 116 (same as in FIG. 1) can communicate with the cloud layer 254 and/or the fog layer 256. The architecture 250 can include one or more communication links 252 between the cloud layer 254, the fog layer 256, and the client endpoints 116. Communications can flow up to the cloud layer 154 and/or down to the client endpoints 116.

The fog layer 256 or “the fog” provides the computation, storage and networking capabilities of traditional cloud networks, but closer to the endpoints. The fog can thus extend the cloud 102 to be closer to the client endpoints 216. The fog nodes 262 can be the physical implementation of fog networks. Moreover, the fog nodes 262 can provide local or regional services and/or connectivity to the client endpoints 116. As a result, traffic and/or data can be offloaded from the cloud 102 to the fog layer 256 (e.g., via fog nodes 262). The fog layer 256 can thus provide faster services and/or connectivity to the client endpoints 116, with lower latency, as well as other advantages such as security benefits from keeping the data inside the local or regional network(s).

The fog nodes 262 can include any networked computing devices, such as servers, switches, routers, controllers, cameras, access points, gateways, etc. Moreover, the fog nodes 162 can be deployed anywhere with a network connection, such as a factory floor, a power pole, alongside a railway track, in a vehicle, on an oil rig, in an airport, on an aircraft, in a shopping center, in a hospital, in a park, in a parking garage, in a library, etc.

In some configurations, one or more fog nodes 262 can be deployed within fog instances 258, 260. The fog instances 258, 258 can be local or regional clouds or networks. For example, the fog instances 256, 258 can be a regional cloud or data center, a local area network, a network of fog nodes 262, etc. In some configurations, one or more fog nodes 262 can be deployed within a network, or as standalone or individual nodes, for example. Moreover, one or more of the fog nodes 262 can be interconnected with each other via links 264 in various topologies, including star, ring, mesh or hierarchical arrangements, for example.

In some cases, one or more fog nodes 262 can be mobile fog nodes. The mobile fog nodes can move to different geographical locations, logical locations or networks, and/or fog instances while maintaining connectivity with the cloud layer 254 and/or the endpoints 116. For example, a particular fog node can be placed in a vehicle, such as an aircraft or train, which can travel from one geographical location and/or logical location to a different geographical location and/or logical location. In this example, the particular fog node may connect to a particular physical and/or logical connection point with the cloud 254 while located at the starting location and switch to a different physical and/or logical connection point with the cloud 254 while located at the destination location. The particular fog node can thus move within particular clouds and/or fog instances and, therefore, serve endpoints from different locations at different times.

FIG. 3 illustrates an example SASE based architecture, according to some aspects of the present disclosure. A SASE based architecture 100 of FIG. 3 includes a SASE controller 302. SASE controller 302 may be a cloud-based component residing on one or more decentralized or centralized servers and communicatively coupled to any number of network devices, servers, etc., including user devices 304, services 312-1 and 312-2, etc. Controller 302 may be a software-defined network such as that described above with reference to FIGS. 1 and 2. Components of controller 302 may include one or more cloud-based headends, one or more CDFW, one or more routers, etc., all of which will be described in more detail with reference to FIG. 4.

Architecture 300 further includes user devices 304 that may remotely connect to controller 302 via any known or to be developed Virtual Private Network (VPN) connection including, but not limited to, Point-to-Point Tunneling Protocol (PPTP), Layer 2 Tunneling Protocol (L2TP), Internet Protocol Security (IPSec), Secure Suckets Layer (SSL), Internet Key Exchange Version 2 (IKEv2), etc.

User devices 304 can be any type of known or to be developed device capable of remotely accessing one or more of services 312-1 and 312-2 via controller 302. For example, user devices 304 can include a laptop, a mobile device, Internet of Things (IoT) devices, a router, a server, etc. User devices 304 may be the same as client endpoints 116 of FIG. 1.

Each user device 304 may connect to controller 302 via a corresponding access point such as access point 306, 308, etc. SASE services provided by controller 302 may include, but are not limited to, security services such as threat intelligence service 310-1, Secure Web Gateway (SWG) service 310-2, CDFW 310-3, Domain Name Services (DNS) 310-4, Cloud Access Security Broker (CASB) services 310-5, etc.

Any one or more of user devices 304 may access any one or more services 312-1 and/or 312-2. Services 312-1 and/or services 312-2 may be private cloud-based services provided by operator of controller 302, third-party cloud-based services, public cloud-based services, and/or a hybrid of the same. For example, a private cloud-based service can be an enterprise 5G service. An example of a third-party cloud-based service can be a cloud-storage service (e.g., Google cloud storage), a cloud-based computing service provided by Amazon, Microsoft, Google, Facebook, etc.

FIG. 4 illustrates several components of a SASE controller, according to some aspects of the present disclosure. In describing FIG. 4, the elements and components that are the same as those described above with reference to FIG. 3 have the same reference numerals in FIG. 4.

In architecture 400, a user device 304 may access controller 302 via access point 308 and establishing a VPN connection to one of remote access headends 402 or 404, depending on the type of VPN connection and the VPN agent installed on user device 304. For example, user device 304 may have a client-based VPN connection agent installed thereon and can thus establish connection over an IPSec tunnel to remote access headend 402. In another example, user device 304 may be a Meraki MX router and thus may establish a connection to a Meraki headend (e.g., headend 404) in order to access services of controller 102. In some examples, any given type of supported VPN connection may have its own headend component on controller 102 for establishing a connection to the corresponding user device 304.

In some examples, headend 402 may be a cloud-edge component configured to couple individual user devices to controller 302 to utilize the SASE environment while remote access headend 404 may perform the same functionalities for an organization (i.e., an entire remotely connected network, a data center, etc.). Aside from this difference, functionalities of headend 402 and 404 may be the same. Furthermore, controller 302 may have other types of headends. Accordingly, headend 402 and remote access headend 404 may collectively be referred to as cloud headends.

Each remote access headend may have corresponding encryption/decryption components, a flow processor, etc. Such components may include any known or to be developed encryption/decryption components, a flow processor, etc.

Once network traffic is received at remote access headend 402 or 404, the network traffic is then routed to a cloud-based router 406. Router 406 may perform any known or to be developed functionalities for routing network traffic to corresponding components for servicing the traffic inside controller 302 and/or alternatively route network traffic to its destination.

Router 406 then forwards the received network traffic to one or more CDFW 408. CDFW 408 may apply any applicable network policy to the received network traffic to determine if the network traffic should be dropped. Such network policies may be configured according to a service level agreement (SLA) between operator(s) of user devices 304 and controller 302′s provider, etc.

CDFW 408, depending on the applicable network policy, may determine that the network traffic from user device 304 should be dropped. In some examples, either directly or through corresponding remote access headend 402 or 404, CDFW 408 may signal (e.g., over a corresponding control plane messaging scheme) user device 304 to future network traffic. In some examples, a decision to drop future packets may not only be based on the applicable network policy but may also depend on the amount of network traffic received at controller 302 (or more specifically at CDFWs 408) and their ability to process/service them. Therefore, packet dropping may also be based on load-balancing and processing capacity at controller 302.

In some examples, such signaling may have an associated duration, upon expiration of which user device 304 may resume sending network traffic to controller 302. In another example, the signaling may include sending an invalidation signal from the controller (e.g., from a CDFW 408) to user device 304 when configuration changes (i.e., changes in applicable policies governing the routing and transmission of network traffic) result in changes that may allow resuming of transmission of data packets by user device 304. In other words, such signaling may include an indication to the user device 304 that it may resume sending data packets because the applied rule that formed the basis for signaling the user device 304 to stop sending traffic to controller 302 is no longer valid, applicable, etc.

In some examples, controller 302 may have one or more associated databases 410. Overtime and as network policies for a given user device 304 (or a family of user devices) change and corresponding decisions are made for allowing/dropping packets, such policies (rules) may be stored in database 410. When user device 304 is detected to come online after a period of inactivity or when user device 304 is the same as another online device with the same network policies applicable thereto, then controller 302, via CDFW 408 can pro-actively signal user device 304 to not send any network traffic to controller 302 (e.g., until further notice) because the history of previously applied rules to user device 304 or devices that are the same as user device 304 may indicate that network traffic originating from user device 304 should be dropped.

FIG. 5 illustrates an example method of managing network traffic in an environment utilizing a SASE architecture, according to some aspects of the present disclosure. FIG. 5 will be described from the perspective of controller 302. However, it will be understood that computer-readable instructions stored on one or more memories may be executed by one or more processors (e.g., residing on cloud-accessible servers) to implement functionalities of various components of controller 302, as described above, to perform steps of the process of FIG. 5 described below.

At S500, controller 302 determines if a user device is detected that is either connecting to controller 302 for the first time or is reconnecting to controller 302 after a period of inactivity/being disconnected (a returning device). This detection may be performed according to any known or to be developed method. The period of inactivity/being disconnected may be a few seconds to minutes, days, etc.. It may be a configurable parameter determined based on experiments and/or empirical studies.

If at S500, controller 302 determines that the user device (e.g., user device 304) is connecting to controller 302 for the first time or is reconnecting to controller 302 after a period of inactivity/being disconnected, then at S502, controller 302 determines if rules for dropping packets exist in a database (e.g., database 410) for the user device.

In some examples such rules may be indicative of past network flow management rules and policies for dropping network traffic. For example, there may be prior rules (historical rules) and network policies indicating that traffic originating from user device 304 during a certain time period and to a certain destination should be dropped. In another example, user device 304 may belong to a category of devices without permission to access certain services and thus any related network traffic should be dropped. These network policies may be stored in database 114. In another example, stored rules and policies may not be specific to user device 304 but may be applicable to a particular (or defined) group of devices to which user device 304 belongs (e.g., certain IoT devices, routers of particular model or make, etc.).

If at S502, controller 302 determines that rule(s) for dropping network traffic from user device 304 exists, then at S504, the existing rule(s) are applied to user device 304, whereby user device 304 is notified to proactive drop network traffic, to which the rule(s) are applicable, at the user device 304 before the network traffic is sent to controller 302. The process then proceeds to S512. This process and mechanic for notifying user device 304 to drop network traffic at user device 304 will be further described below with reference to S512 and S514.

However, if at S502, controller 302 determines that no rules for dropping network traffic exists, the process proceeds to S506, which will be described below.

Referring back to S500, if controller 302 does not determine user device 304 to be a new or returning device, then at S506, controller 302 receives network traffic from user device 304. This network traffic may be received after user device 304 successfully establishes a VPN connection to controller 304 according to any known or to be developed VPN connection mechanism/protocol (e.g., PPTP, IPSec, L2TP, SSL, IKEv2, etc.).

At S508, controller 302 sends the network traffic received at S506, to one or more cloud-delivered firewall devices (e.g., CDFWs 408) for analysis. CDFW 408 may analyze the network traffic and apply appropriate network policies and rules to determine if the network traffic should be dropped. Such rules and network policies may be based on amount of network traffic and whether the incoming traffic from user device 304 exceeds a corresponding threshold. In another example, a network policy may be such that certain network traffics (e.g., to and from specific destinations) that originate from user device 304 should be dropped. While a few specific examples of rules and network policies are provided here, the present disclosure is not limited thereto and any number of rules and network policies may be applied.

At S510, controller 302, using CDFW 408, determines if the network traffic from the user device should be dropped. This determination may be based on applying relevant rules and network policies described above.

If at S510, controller 302 determines that the network traffic from the user device should not be dropped, the process reverts back to S500 and steps S500 to S510 may be repeated as applicable.

However, if at S510, controller 302 determines that the network traffic from the user device should be dropped, then at S512, controller 302 determines a type of connection (e.g., the type of VPN connection) over which user device 304 is connected to controller 302 of the SASE based system. Examples of different types of connections include, but are not limited to, PPTP, IPSec, L2TP, SSL, IKEv2, etc., as described above.

At S514, controller 302 signals a message to user device 304 to drop future network traffic at the user device prior to sending the network traffic to a remote access headend (e.g., remote access headend 402) at controller 302. In some examples, this message may be sent to user device 304 as a control message (a new message or as part of an existing message) using control protocol/messaging that corresponding to the type of connection identified at S512. For example, the type of message send to user device 304 to drop future packets/network traffic may be different if the user device 304 has established an IPSec connection to remote access headend 402 compared to when such connection is SSL, IKEv2, etc.

In some examples, user device 304 may not support functionalities for receiving rules for dropping network traffic, analyze/apply the rules received as part of the message sent at S514, dropping network traffic, etc. In other words, user device 304 may not be capable of receiving and executing computer-readable codes for receiving the rules, analyze/apply them, and/or drop network traffic. In this instance and according to one aspect of the present disclosure, the controller 302 (e.g., router 406) may send the message to the edge component at controller 302 configured to receive network traffic from user device 304 (e.g., a corresponding headend for user device 304 such as headend 402 or 404). In this instance, the network traffic will be received from user device 304 at the corresponding headend and will be dropped at the headend before reaching other components inside controller 302 (e.g., before reaching CDFW 408).

By implementing the process of FIG. 5, the present disclosure provides a solution to manage network traffic in a SASE based environment in order to optimize resource utilization at various components within a cloud-based SASE controller. In some examples, network traffic management in a SASE architecture includes a determination at the cloud-based SASE controller (e.g., a datacenter) that certain network traffic from certain remotely connected user devices should be dropped followed by a pre-emptive dropping of such traffic at the corresponding remotely connected user device before the traffic reaches a headend component at the cloud-based SASE controller.

With example systems and methods for managing network traffic in a SASE environment described with reference to FIGS. 1-5, the disclosure now turns to description of system architecture and devices that can be utilized as components of controller 302 or any other component described above with reference to FIGS. 1-5.

FIG. 6 illustrates a computing system architecture, according to some aspects of the present disclosure. Components of computing system architecture 600 are in electrical communication with each other using a connection 605, such as a bus. Exemplary system 600 includes a processing unit (CPU or processor) 610 and a system connection 605 that couples various system components including the system memory 615, such as read only memory (ROM) 620 and random access memory (RAM) 625, to the processor 610. The system 600 can include a cache 612 of high-speed memory connected directly with, in close proximity to, or integrated as part of the processor 610. The system 600 can copy data from the memory 615 and/or the storage device 630 to the cache 612 for quick access by the processor 610. In this way, the cache 612 can provide a performance boost that avoids processor 610 delays while waiting for data. These and other modules can control or be configured to control the processor 610 to perform various actions. Other system memory 615 may be available for use as well. The memory 615 can include multiple different types of memory with different performance characteristics. The processor 610 can include any general purpose processor and a hardware or software service, such as service (SVC) 1 632, service (SVC) 2 634, and service (SVC) 3 636 stored in storage device 630, configured to control the processor 610 as well as a special-purpose processor where software instructions are incorporated into the actual processor design. The processor 610 may be a completely self-contained computing system, containing multiple cores or processors, a bus, memory controller, cache, etc. A multi-core processor may be symmetric or asymmetric.

To enable user interaction with the computing device 600, an input device 645 can represent any number of input mechanisms, such as a microphone for speech, a touch-sensitive screen for gesture or graphical input, keyboard, mouse, motion input, speech and so forth. An output device 635 can also be one or more of a number of output mechanisms known to those of skill in the art. In some instances, multimodal systems can enable a user to provide multiple types of input to communicate with the computing device 600. The communications interface 640 can generally govern and manage the user input and system output. There is no restriction on operating on any particular hardware arrangement and therefore the basic features here may easily be substituted for improved hardware or firmware arrangements as they are developed.

Storage device 630 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 625, read only memory (ROM) 620, and hybrids thereof.

The storage device 630 can include services 632, 634, 636 for controlling the processor 610. Other hardware or software modules are contemplated. The storage device 630 can be connected to the system connection 605. In one aspect, a hardware module that performs a particular function can include the software component stored in a computer-readable medium in connection with the necessary hardware components, such as the processor 610, connection 605, output device 635, and so forth, to carry out the function.

FIG. 7 illustrates an example network device, according to some aspects of the present disclosure. Example network device 700 can be suitable for performing switching, routing, load balancing, and other networking operations. Network device 700 includes a central processing unit (CPU) 704, interfaces 702, and a bus 710 (e.g., a PCI bus). When acting under the control of appropriate software or firmware, the CPU 704 is responsible for executing packet management, error detection, and/or routing functions. The CPU 704 preferably accomplishes all these functions under the control of software including an operating system and any appropriate applications software. CPU 704 may include one or more processors 708, such as a processor from the INTEL X86 family of microprocessors. In some cases, processor 708 can be specially designed hardware for controlling the operations of network device 700. In some cases, a memory 706 (e.g., non-volatile RAM, ROM, etc.) also forms part of CPU 704. However, there are many different ways in which memory could be coupled to the system.

The interfaces 702 are typically provided as modular interface cards (sometimes referred to as “line cards”). Generally, they control the sending and receiving of data packets over the network and sometimes support other peripherals used with the network device 700. Among the interfaces that may be provided are Ethernet interfaces, frame relay interfaces, cable interfaces, DSL interfaces, token ring interfaces, and the like. In addition, various very high-speed interfaces may be provided such as fast token ring interfaces, wireless interfaces, Ethernet interfaces, Gigabit Ethernet interfaces, ATM interfaces, HSSI interfaces, POS interfaces, FDDI interfaces, WIFI interfaces, 3G/4G/5G cellular interfaces, CAN BUS, LoRA, and the like. Generally, these interfaces may include ports appropriate for communication with the appropriate media. In some cases, they may also include an independent processor and, in some instances, volatile RAM. The independent processors may control such communications intensive tasks as packet switching, media control, signal processing, crypto processing, and management. By providing separate processors for the communications intensive tasks, these interfaces allow the master CPU 704 to efficiently perform routing computations, network diagnostics, security functions, etc.

Although the system shown in FIG. 7 is one specific network device of the present technology, it is by no means the only network device architecture on which the present technology can be implemented. For example, an architecture having a single processor that handles communications as well as routing computations, etc., is often used. Further, other types of interfaces and media could also be used with the network device 700.

Regardless of the network device’s configuration, it may employ one or more memories or memory modules (including memory 706) configured to store program instructions for the general-purpose network operations and mechanisms for roaming, route optimization and routing functions described herein. The program instructions may control the operation of an operating system and/or one or more applications, for example. The memory or memories may also be configured to store tables such as mobility binding, registration, and association tables, etc. Memory 706 could also hold various software containers and virtualized execution environments and data.

The network device 700 can also include an application-specific integrated circuit (ASIC), which can be configured to perform routing and/or switching operations. The ASIC can communicate with other components in the network device 700 via the bus 710, to exchange data and signals and coordinate various types of operations by the network device 700, such as routing, switching, and/or data storage operations, for example.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Claim language reciting “at least one of” refers to at least one of a set and indicates that one member of the set or multiple members of the set satisfy the claim. For example, claim language reciting “at least one of A and B” means A, B, or A and B.

What is claimed is:

1. A method comprising:
determining, by a controller of a cloud-based secure access service, that data packets from a user device should be dropped, a plurality of user devices, including the user device, being remotely connected to the controller for access to the cloud-based secure access service;
determining, by the controller, a type of remote connection through which the user device is connected to the controller, each type of remote connection having a corresponding communication prototype; and
transmitting a message, by the controller, to the user device, over a control protocol corresponding to the type of remote connection through which the user device is connected to the controller, the message providing a signal to the user device to drop packets at the user device prior to sending the packets to the controller.

2. The method of claim 1, wherein the user device is connected to the controller through a cloud headend of the controller.

3. The method of claim 1, wherein determining that the data packet should be dropped comprises:
identifying the user device;
determining that at least one prior rule for network traffic management are stored for the user device; and
transmitting, before receiving the data packets, a message using the control protocol to direct the user device to proactively drop future traffic originating from the user device based on the at least one prior rule.

4. The method of claim 3, wherein the proactive dropping of future traffic is implemented upon the user device reconnecting to the cloud-based secure access service.

5. The method of claim 3, wherein the proactive dropping of future traffic is implemented upon the user device connecting to the cloud-based secure access service for a first time.

6. The method of claim 5, wherein the at least one prior rule is stored with reference to management of network traffic of at least one other remotely connected device of the same type as the user device.

7. The method of claim 1, wherein the data packets are determined to be drop by a cloud-delivered firewall service at the controller.

8. The method of claim 1, wherein determining that the data packet should be dropped comprises:
receiving a data packet from the user device at a remote access headend of the controller;
sending the data packet from the remote access headend to a routing component of the controller; and
sending the data packet from the routing component to at least one cloud-delivered firewall of the cloud-based secure access service.

9. A cloud-based secure access service comprising:
a controller configured to:
determine that data packets from a user device should be dropped, a plurality of user devices, including the user device, being remotely connected to the controller for access to the cloud-based secure access service;
determine a type of remote connection through which the user device is connected to the controller, each type of remote connection having a corresponding communication prototype; and
transmit a message to the user device, over a control protocol corresponding to the type of remote connection through which the user device is connected to the controller, the message providing a signal to the user device to drop packets at the user device prior to sending the packets to the controller.

10. The cloud-based secure access service of claim 9, wherein the user device is connected to the controller through a cloud headend of the controller.

11. The cloud-based secure access service of claim 9, wherein the controller is configured to determine that the data packet should be dropped by:
identifying the user device;
determining that at least one prior rule for network traffic management are stored for the user device; and
transmitting, before receiving the data packets, a message using the control protocol to direct the user device to proactively drop future traffic originating from the user device based on the at least one prior rule.

12. The cloud-based secure access service of claim 11, wherein the proactive dropping of future traffic is implemented upon the user device reconnecting to the cloud-based secure access service or the user device connecting to the cloud-based secure access service for a first time.

13. The cloud-based secure access service of claim 9, wherein the data packets are determined to be drop by a cloud-delivered firewall service at the controller.

14. The cloud-based secure access service of claim 9, wherein the controller is configured to determine that the data packet drop should be dropped by:
receiving a data packet from the user device at a remote access headend of the controller;
sending the data packet from the remote access headend to a routing component of the controller; and
sending the data packet from the routing component to at least one cloud-delivered firewall of the cloud-based secure access service.

15. One or more non-transitory computer-readable media comprising computer-readable instructions, which when executed by a controller of a cloud-based secure access service, causes the controller to:
determine that data packets from a user device should be dropped, a plurality of user devices, including the user device, being remotely connected to the controller for access to the cloud-based secure access service;
determine a type of remote connection through which the user device is connected to the controller, each type of remote connection having a corresponding communication prototype; and
transmit a message to the user device, over a control protocol corresponding to the type of remote connection through which the user device is connected to the controller, the message providing a signal to the user device to drop packets at the user device prior to sending the packets to the controller.

16. The one or more non-transitory computer-readable media of claim 15, wherein the user device is connected to the controller through a cloud headend of the controller.

17. The one or more non-transitory computer-readable media of claim 15, wherein execution of the computer-readable instructions by the controller, causes the controller to determine that the data packet should be dropped by:
identifying the user device;
determining that at least one prior rule for network traffic management are stored for the user device; and
transmitting, before receiving the data packets, a message using the control protocol to direct the user device to proactively drop future traffic originating from the user device based on the at least one prior rule.

18. The one or more non-transitory computer-readable media of claim 17, wherein the proactive dropping of future traffic is implemented upon the user device reconnecting to the cloud-based secure access service or the user device connecting to the cloud-based secure access service for a first time.

19. The one or more non-transitory computer-readable media of claim 15, wherein the data packets are determined to be drop by a cloud-delivered firewall service at the controller.

20. The one or more non-transitory computer-readable media of claim 15, wherein execution of the computer-readable instructions by the controller, causes the controller to determine that the data packet drop should be dropped by:
receiving a data packet from the user device at a remote access headend of the controller;
sending the data packet from the remote access headend to a routing component of the controller; and
sending the data packet from the routing component to at least one cloud-delivered firewall of the cloud-based secure access service.
